(19) United States
(12) Patent Application Publication
(10) Pub. No.: US 2018/0276741 A1
(43) Pub. Date: Sep. 27, 2018

(54) EQUIPMENT STAGING METHOD AND SYSTEM

(71) Applicant: United Rentals, Inc., Stamford, CT (US)

(72) Inventors: Ron GROFF, Roseville, CA (US); Michael R. BROWN, Highlands Ranch, CO (US); Brent McINTURF, Felton, CA (US); Zackary THOMPSON, Sacramento, CA (US)

(21) Appl. No.: 15/516,815

(22) PCT Filed: Jun. 19, 2015
(86) PCT No.: PCT/US2015/036698

§ 371 Date: Apr. 4, 2017

(51) Int. Cl. G06Q 30/06; G06F 17/30; G06Q 10/06

(52) U.S. Cl. CPC G06Q 30/0645; G06Q 10/06313; G06F 17/30312

(57) ABSTRACT

In various embodiments, a method and system for staging equipment rentals is given. In association with an equipment rental facility, a specified function is identified to be performed, such as loading an equipment asset on a vehicle. Parameters associated with an equipment rental reservation are identified and assigned a value. Based on the values so assigned, staging activities can be developed and modified, determined by a rule-based mechanism. Adjustments can be made to the nature, scope and timing of staging activities based on changes in the value(s) of reservation parameters.

### BACKGROUND

Equipment rental providers give customers as-needed access to equipment and tools of all kinds for construction, industrial and residential uses where customers are free from the burden of capital investment, storage and maintenance associated with equipment ownership. From backhoes to bulldozers, trench brace systems to transformers, generators to excavators, and for items that can weigh several pounds to many tons, more than 3000 types of equipment and tools can be made available for short- or long-term rental for nearly any purpose. The ready availability of such rentals yields efficient use of resources from large commercial enterprises to individual homeowners, promoting economic growth and productivity.

A given equipment rental facility can have hundreds of category-types of equipment or tools, and even more than one thousand. Typically there is constant vehicular traffic entering and exiting the site to take possession of and/or unload equipment, with trucks and other carriers loading and unloading. The facility itself can have significant vehicular congestion, not to mention foot traffic by customers or drivers acting as their agents, creating potential inefficiencies, delays and safety issues from contending with large and sometimes hazardous items. In addition, customers often look to equipment rental providers for heavy equipment, which not only can weigh many tons but be bulky, unwieldy or otherwise difficult to transport within the facility. Further, with the ever-increasing demand for equipment rental, sites must handle dozens if not more loadings and unloadings a day.

There is a need for efficient methods and systems for efficiently matching customers with equipment to maximize throughput in an equipment rental site, thus promoting best utilization of equipment, generating higher revenues, and enhancing customer and employee safety.

### DRAWINGS

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of a method for staging equipment rental assets.

FIG. 2 illustrates one embodiment of a computing environment for staging equipment rental assets.

FIG. 3 illustrates one embodiment of an equipment rental facility configured for staging equipment rental assets.

### DESCRIPTION

In various embodiments, methods and systems for equipment rental are disclosed.

It will be appreciated that there are numerous challenges for equipment rental entities. A desired equipment asset can be in control of the equipment rental entity but not be located on site at a facility. An equipment asset can be physically on site, but not at a suitable location for taking possession by a customer on site (e.g., blocked by other equipment assets, in an area with substantial foot traffic and so difficult to take possession of, etc.). Also, an equipment asset may be on site and at a suitable physical location for possession to be taken, but not be ready (maintenance may not be completed, or proper approvals may not have been obtained). And, if an equipment asset is on site, at a suitable physical location for transfer of possession, and ready for transfer of possession, an employee of the equipment rental company may be tied up with other customer matters. Even more, if an equipment asset is on site, at a suitable physical location for transfer of possession, and is ready for transfer of possession to a customer, and the employee is set to provide the equipment asset to a customer, the customer could cancel at the last minute, meaning that this equipment asset—which can weigh many tons, and be cumbersome—may now block other loadings or unloadings.

Staging can be considered deploying equipment assets in such a way as to enhance, maximize and/or optimize efficient transfer of possession of an equipment asset to a customer. Staging methods and systems can comprise deploying assets in a certain manner in an equipment rental facility, implementing certain processes with predetermined activities and/or sequences, and configuring computer-based applications to deploy assets in a predetermined manner. As used herein, “customer” can mean the paying customer to whom an equipment asset will be delivered at a place of the customer's choosing or for whom a staging activity will be performed at the equipment rental site; thus such customer can take possession at the equipment rental facility or at a place of the customer's choosing. Further, in a suitable context “customer” can also mean a driver engaged at the direction of the equipment rental facility who can take possession of and deliver the equipment asset to an ultimate customer.

Reference will now be made in detail to several embodiments, including embodiments showing example implementations of staging methods and systems for equipment rental. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

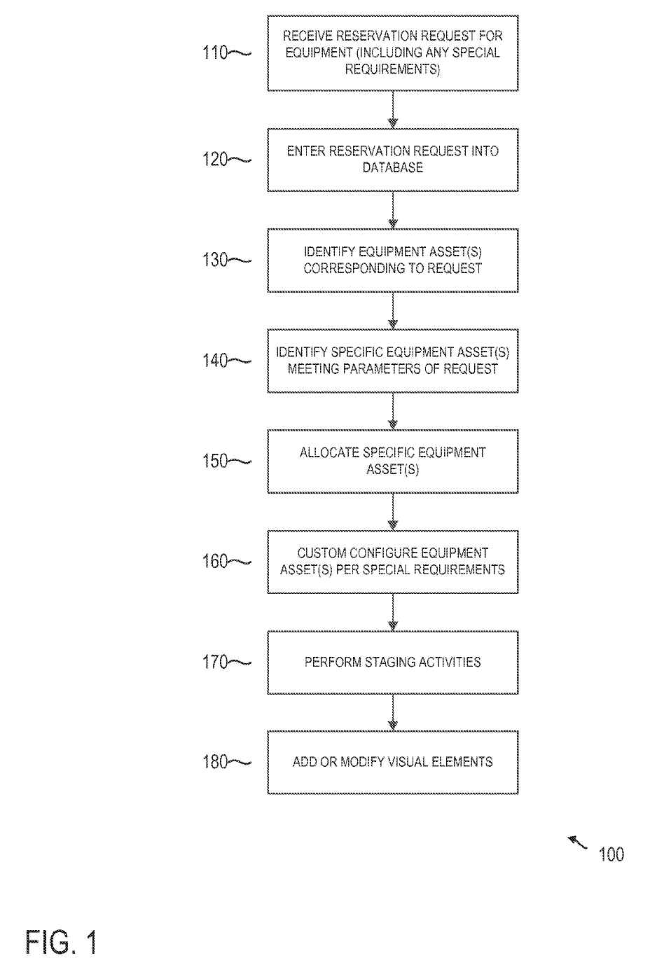

In various embodiments, as shown by way of non-limiting in example in FIG. 1, a method of staging equipment 100 can be employed by receiving a request for equipment (including any special requirements) 110.

In example embodiments, suppose that a user wishes to rent a dozer. This equipment asset is heavy. Although it can be maneuvered, it can be blocked by additional items, and by its nature moving it can jeopardize the integrity of additional equipment assets that are in the path of the blade. Further, it can create a safety issue for individuals as it moves at an equipment rental site, either placed on a delivery vehicle or on its own power. Even more, “traffic jams” can be created in the yard where two or more vehicles that are to take possession of equipment can be moving about in search of equipment assets, or en route to leave the yard, or both. In other words, it is not a trivial matter to position a dozer for transfer of possession to a vehicle such as a flatbed truck in the first place; in addition, it is not trivial to reposition if, for some reason, this becomes a necessity.

Similar properties can be associated with slow-moving equipment, however much it may weigh. One method of addressing such is to position such equipment more toward the back of the facility so that entering and exiting the facility is as unimpaired as possible by such equipment.

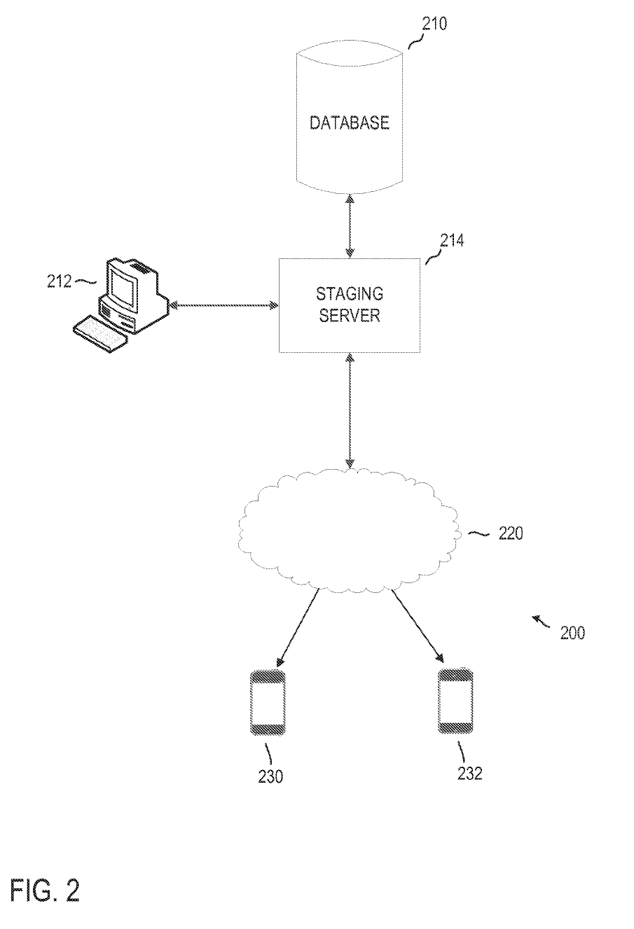

Upon receiving a reservation request for equipment 110, the equipment rental entity can enter, or otherwise record, such request. In other words, the request can be entered in a database(s) 120, such as a database(s) 210 depicted in FIG. 2, via a computer device. The request can be directly entered into a database 210 by the customer, or by an individual in association with the equipment rental facility. FIG. 2 can illustrate a computing environment 200 for assisting with implementation of a method of staging equipment rentals. Database 210 can be operatively associated with staging server 214. Staging server 214 can be operatively associated with computer, input device and display 212. Computer, input device and display 212 can contain or be operatively associated with a processor(s), and with memory(ies) which may include software applications. Computer, input device and display 212 can comprise a personal computer, a laptop, a tablet, a mobile device such as a smart phone, smart glasses, or a smart watch; it will be appreciated that any device containing or in operative association with a processor(s) and a memory(ies) can serve the purpose of computer and input device 212. Staging server 214 can be in operative communication with a network 220. Network 220 can permit operative communication of the foregoing functionalities with mobile devices 230, 232. It is understood that some or all of the foregoing functionalities can be in operative communication via one or more networks, wired or wireless. Each of the foregoing functionalities can be controlled by mechanism of software instructions embodied in a non-transitory computer medium.

It can be appreciated that a “promise date” and “promise time” can be provided. A promise date can be considered the date when equipment is scheduled for transfer of possession to a customer. A promise time can be considered a time when a customer is scheduled to take possession of equipment as at the equipment rental facility, or take delivery of equipment at a place of the customer's preference such as a jobsite. Characterized as a promise date and promise time because of a commitment to meet customer needs, these terms can also relate to dates or times, as appropriate, of delivering equipment to a location of the customer's choice or providing it for transfer of possession by the customer at the equipment rental facility. Using this terminology, a “needs by” date and “needs by time” can be provided. A needs by time can be set by a default. Such default can be provided as promise time minus three hours, although other periods can be used. It will be appreciated that decisions and actions related to staging activities can depend on both promise time and needs by time. Where a promise time is provided, a needs by time can also be provided a predetermined period prior to the promise by time.

Adjustments to other parameters can influence the needs by time; correspondingly adjustments to the needs by time can influence other parameters. In addition, if the promise time is adjusted, such as by a customer wishing an earlier delivery, the needs by time can be adjusted as well. The needs by time can be manually adjusted, and doing so can change a priority accorded a reservation parameter and a reservation record.

In other words, adjustment of one parameter, such as but not limited to a needs by time, can influence priorities, decisions and actions taken in regard to another parameter or even the same parameter.

A reservation, as recorded in the system, can be associated with numerous reservation parameters. By way of non-limiting embodiment, such reservation parameters can comprise one or more of: customer promise date; customer promise time; loading location; expected return date; expected return time; expected return location; a “needs by” time (e.g., when a customer states that it needs the asset by, or a time that facility personnel deem the customer needs it by); equipment asset class; specific equipment asset; area specific equipment is located within facility (including distance from: computer device that can record reservation, main building at facility, facility entrance, facility exit, loading area, unloading area, fueling area); expected time driver will arrive at facility; distance of driver from facility; when specific equipment asset last rented; meter (usage measurement) on specific equipment asset; date of acquiring specific equipment asset; brand of equipment asset; lane or lanes truck expected to use; type and/or color of cone that can be placed in or near staging area; shape of vehicle path associated with particular staging activity; errors, warnings or safety statuses; is equipment considered “slow” or “heavy”; is the reservation considered “canceled” or “modified”; does the customer have special requirements or preferences; rental rates; revenue management; amount of time that an equipment asset is unavailable (for maintenance, because it was rented, or for other reasons); and others. In other words, the foregoing represent example reservation parameters that can be used in connection with equipment rental.

By way of non-limiting example, rules can be based on: minimizing time spent in the facility per each load/unloading event, by a driver, or facility personnel; maximizing likelihood equipment will be available for transfer of possession; maximizing customer satisfaction; maximizing revenue or profit, e.g., by allocating less-used items before more-used ones to enhance overall equipment longevity; enhancing efficiency; maximizing safety; weight of equipment; priority; location of staging areas; and others.

As can be seen above, reservation parameters can reflect values made along a continuous axis (e.g., time in increments of 5 minutes that driver is away from facility, usage level of equipment asset). In addition, parameters can also be represented as binary values, e.g., is there an error condition or not, is the driver more than three hours away or not, is the specific equipment asset considered “rental ready” or not. Reservation parameters can also comprise predetermined identifiers such as identity of a customer who is entitled to certain services. Relatedly, certain reservation parameters can be assigned a higher priority or lower priority, and under certain circumstances priority values can represent a spectrum of measurements (a set of priority values along a scale), and under certain circumstances priority values can be represented in a binary fashion (where there is either priority, or no priority). Rules can thus designate which values of a single reservation parameter may be accorded priority, and which may not. There may be rules combining two or more rules: i.e., if a certain priority condition is determined, then this is an input into a second priority condition. Such values can be entered, stored, and calculated electronically. A priority value(s) itself can comprise a reservation parameter(s), e.g., where a “high” or greater priority is considered, this can be a reservation parameter in and of itself. In addition, priority can be given a numerical value, such as a priority scale of 1 to 10, where 1=lowest priority, and 10=highest priority. Based on an adjustment of the priority, value an adjustment of an equipment staging function or equipment staging location can be made.

Once a reservation parameter is adjusted, a staging activity can be adjusted as well. For example, if a customer promise time (e.g., when the equipment is scheduled for a customer to take possession) is adjusted to a later time, then a change to this reservation parameter (customer promise time) can result in removing a first equipment asset from a staging area to make room for a second equipment asset. Once the second equipment asset is removed by a customer, the first asset can be positioned in the staging area. If it is determined that a driver will arrive at the facility earlier than expected, this adjustment to the reservation parameter (expected time of arrival) can result in moving an equipment asset to a staging area earlier than otherwise planned, can result in staging in a different location in the facility, etc. it will be appreciated that a “needs by” value can be changed to accomplish one or both of the foregoing examples. Further, if it is determined that an equipment asset that has been allocated to a specific customer is in need of maintenance this adjustment to the reservation parameter (maintenance status) can result in moving the asset out of a staging area and moving a satisfactory equipment asset into the staging area. In addition, parameters such as priority can be used. For example, if a certain priority level has been assigned to a staging activity, then an adjustment to the reservation parameter (priority) can result in rearranging a queue of tasks by which staging is accomplished, can result in physically positioning a first equipment asset in the staging area rather than a second one, etc. It will be appreciated that many more adjustments to a reservation parameter can be made, and accompanying changes can be made to a staging activity.

Continuing with the example of the expected time of arrival, multiple approaches can be used. For example, a binary determination can be made where a certain time is selected to reflect a rule, e.g., three hours or more=“no”, less than three hours=“yes”, wherein a “no” can reflect do not carry out a certain adjustment or staging activity, and a “yes” can indicate carry out a certain adjustment or staging activity. In addition, a gradational determination and/or weighting can be made, e.g., three hours or more=0%, two hours=50%, one hour=90%, half an hour=95%, etc. The percent value can be used to make added determinations. It can also reflect confidence levels that can be integrated into the calculations. The percent value can also reflect assignment of a priority value, e.g., 80% or higher=high priority, 20% or lower=low priority, etc. It will be evident that many scales, and assignments of values, can be used.

Based on the above disclosure, it will be understood that a change in a value of a reservation parameter can result in adjusting an equipment staging function or equipment staging location. By way of non-limiting example, if a driver is four hours away a decision can be made not to assign a specific location in the facility for the staging activity; however, if a driver is three or fewer hours away then a decision can be made to assign a specific location in the facility for the staging activity.

Database 210 can be structured such that the first reservations request 110 in time may be, or may not be, the first acted upon. The first request may be for an equipment asset that needs significant time to prepare; the asset can be out of inventory (perhaps expected back later in the day or in coming days); the request may be non-urgent and there may be urgent requests so that, based on allocation of yard resources, the request for the dozer is not the first acted upon; the driver of the truck that is to take possession of the dozer may be three hours away from the yard, but there are several other drivers coming to take possession of equipment who are within an hour from the yard. In other words, there are several variables that can be considered in order to determine which staging activities occur and in which order, including priority rules.

Accordingly, a queue may exist or be established such that the dozer request is placed in the queue in database 210. Additionally, a request can be placed in a database but not expressly in a queue data structure or functional equivalent. Communications, including reservations and instructions, workflow interactions and/or comments, can be recorded in a computer device located more proximate to the desired equipment and/or staging area. A benefit is to reduce cycle time by personnel who are processing staging transactions, allow more transactions, and in addition accuracy may be enhanced. Physical proximity of the device to the staging area can be understood as being within approximately 50 feet of the intended staging activity. In addition, physical proximity denotes that the device is outside in the yard itself, and reasonably mobile so that the person interacting with the device can relatively easily move about.

In embodiments some or all components of computing environment 200 can contribute to managing and executing steps for staging equipment rental such as some or all of those in FIG. 1. Some or all determinations and assessments made can be accomplished in association with computing environment 200.

In embodiments, once a request for equipment has been entered, equipment can be identified that can meet the request 130. For example, suppose that a customer requests a 70 horsepower dozer. A review can be made by or in association with the equipment rental site whether and to what extent a 70 hp dozer is available. There may, of course, be zero, one, two or more 70 hp dozers.

Even as potential equipment assets have been identified, it does not necessarily follow that one or more assets so identified are suitable for rental under specified parameters. For example, a category-class can be identified in conjunction with identifying equipment assets 130, and an inventory taken of equipment assets available within that category-class; however, some equipment assets may not be available. Accordingly, specific equipment assets can be identified that meet the parameters of the request 140. For example, consideration can be given to whether one or more dozers meeting the description are rental-ready, i.e., in a position to be rented at the given time. There may be a dozer, but it may require maintenance, it may have been promised to a third party, or there is another reason why the dozer cannot be considered a match. However, in embodiments, depending on desired mechanisms for a process of staging equipment assets, each asset in a category-class (or suitable classes) can be considered a match, and then a further screen be made to determine if the asset can be considered acceptable. In other words, each of the three dozers on site may be considered a match, but one may be disqualified because it is due for periodic or other maintenance, leaving the remaining two 70 hp dozers a match. In addition, a search can be undertaken to determine if a nearby facility(ies) has a dozer, whether or not the primary facility has an equipment asset corresponding to the request.

Once a set of equipment asset(s) has been identified 140, an asset(s) can be allocated to the customer 150. In other words, it can be determined that the equipment asset(s), which could have been associated with any suitable customer, is to be associated with a specific customer. Thus, here it can be determined that a 70 hp dozer with serial number 1,234,567 be allocated to the customer.

The equipment asset(s) so allocated 150 can now be custom-configured per any special requirements by the customer 160. It will be appreciated that in embodiments it is optional for a customer to be allowed to request a custom-configured asset, that the equipment rental entity in fact will custom-configure the equipment, or both.

Staging activities can now be performed 170. Staging activities can include, one, some, many or all of the following.

An area of the yard can be identified where an allocated equipment asset can be positioned. The asset can be pre-placed in this area prior to the vehicle's entering the yard. In fact, the allocated equipment asset can be positioned in this area many minutes or even hours prior to the vehicle's entering the yard. Notification of the expected vehicle arrival time can be communicated to the equipment rental entity by telephone, text, walkie-talkie, software application (mobile-based, or not) or other electronic mechanism of communication. Such notification can be made in conjunction with computer-system 200. For example, mobile device 230, which can be in possession of the driver of the vehicle, can engage in communication with staging server 214, database 210 and computer 212 as part of the process. In embodiments, database 210 is a standalone database; in other embodiments, mobile device 230 can comprise some or all of the functionality of database 210. It will also be appreciated that mobile device 230 can be in possession of an employee or associate of the equipment rental company within or adjacent to the facility.

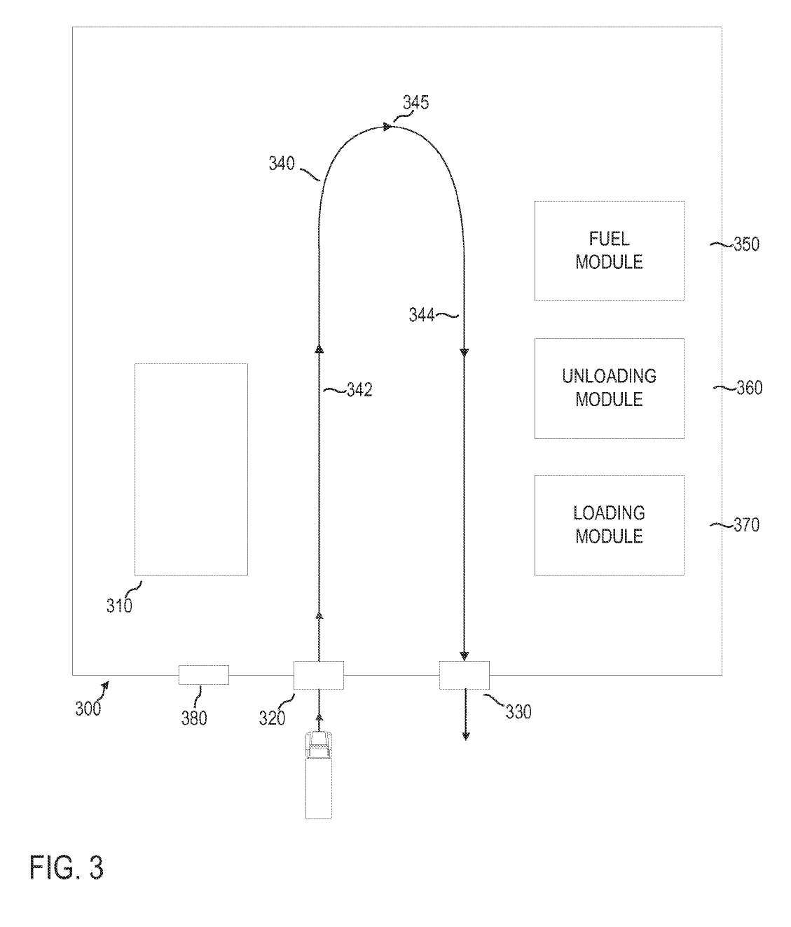

The staging activities within the facility 300 can include one or more activity modules 350, 360, 370, as seen in FIG. 3. Activity modules 350, 360, 370 can be positioned in a predetermined portion of the staging area. In embodiments, activity modules can be on the driver side as a vehicle travels through facility 300; they can also be positioned on the passenger side, or a combination of driver and passenger sides. These modules can include a fuel module 350 where the vehicle that is to take possession of the allocated equipment asset, or deliver the asset, can be fueled. An added activity module can include an unloading module 360. Here equipment riding with the arriving vehicle can be unloaded. In addition, loading can take place at this module as appropriate.

An added activity module can be a loading module. The allocated equipment asset can be prepared for loading onto the arriving vehicle. A gravel surface can be used for this module and additional activity modules. Electricity can be used with this loading module, one reason being that it facilitates use of a scissors. An activity module, then, can comprise at least two components: a function that is to be performed (e.g., fueling), associated with a location in the facility where the function is to be performed (e.g., located on the exit path 344 of a vehicle). For context, a vehicle, after entering at entry gate 320 can travel on a predetermined path 340. Predetermined path 340 can comprise an entry path 342 wherein the vehicle is substantially moving into the facility from outside, and an exit path 344 as the vehicle is moving substantially toward the outside of facility 300 beyond an exit gate 330.

Performing one or more staging activities substantially in advance of an arriving vehicle can contribute positively to turnaround time, i.e., time spent by a vehicle between entering at entry gate 320 and exiting at the gate 330. In addition, arranging for staging in advance can help to smooth inconveniences and/or increase margin for error if, for example, a requested equipment asset is not ready in time (because another can be used), if a customer request is canceled (or modified), and so on. Arranging for staging in advance can help if equipment to be staged is placed in a designated area, such as in association with activity module 370, 1 to 3 hours prior to truck arrival.

A device(s) containing software applications that can assist with the equipment staging process can include relatively stationary device(s) such as a PC(s) 212 in a designated location in the yard, or such as in office 310 (which can be collocated with a shop or storage building) with associated monitor displaying the queue. The queue on the display can list tasks to be performed in order of priority. In addition, to the extent that a task is not subject to priority rules, the task can simply be shown on the display independent of a predesignated order. All tasks can be subject to priority rules, no tasks can be subject to priority rules, or there can be a combination. Priority rules can reflect one or more components of a priority parameter, wherein the priority parameter is a measurement or assessment that influences whether a first equipment rental be given lesser or greater priority than a second equipment rental. Values associated with reservation parameters can be quantified such that priority rules can be developed. For example, time periods of less than a certain time period, such as half an hour, can be assigned a first priority, and more than this can be assigned a second priority.

It will also be appreciated that adjustments may need to be made to a reservation parameter. The decision to make an adjustment, which may be referred to as an adjustment determination, and which can be based on predetermined rule-based methods of decision making, may reflect the following. An adjustment may be more likely the longer lead time anticipated between a notification by the driver, or other customer representative, of the arrival time of the driver vehicle. For example, a compressor allocated to customer one, who is due to arrive in three hours, may be the only asset that can meet the needs of customer two, who is due to arrive in one hour. In a situation like this, the asset can be reallocated from customer one to customer two, and then a second suitable asset from the category class of the asset can be reallocated to customer two. There may be a rule built in that such a reallocation can be made only where there is a certain degree of likelihood (which could be 100%) that a suitable asset of the same or similar category class can be provided to the customer from whom the asset has been “taken”. Neither customer one nor customer two is or will become aware of whether the equipment asset made available to such customer was reallocated. The reallocation may occur in light of shifting priorities based on predetermined priority rules.

Reservation parameters can be adjusted as circumstances warrant. Thus, adjustment determinations can be made for multiple reservation parameters including but not limited to the following. Customer promise date, time and location can be adjusted to accommodate an earlier-arriving or later-arriving customer, or for efficiently assigning equipment assets on a given day to multiple customers, and generally to suit the interests of a customer, or the facility or both. Expected return date, time, and location can be adjusted to suit the interests of a customer, or the facility or both. A “needs by” time can be adjusted generally to suit the interests of a customer, or the facility or both. Adjustments can be made to the equipment asset class, specific equipment asset, area specific equipment is located within facility (including distance from: computer device that can record reservation, main building at facility, facility entrance, facility exit, loading area, unloading area, fueling area), generally to suit the interests of a customer, or the facility, or both. Adjustments can be made to a reservation parameter based on expected time driver will arrive at facility, and/or distance of driver from facility, generally to suit the interests of a customer, or the facility, or both. Adjustments can be made based on when a specific equipment asset was last rented, meter (usage measurement) on specific equipment asset, and/or date of acquiring specific equipment asset, generally to suit the interests of a customer, or the facility, or both. The brand of equipment asset can result in an adjustment, such as customer preference or that of the facility. The lane or lanes a vehicles is expected to use, type and/or color of cone that can be placed in or near staging area, can be adjusted, generally to suit the interests of a customer, or the facility, or both. In addition, a shape of vehicle path associated with particular staging activity can be adjusted. Further, errors, warnings or safety statuses; is equipment considered “slow” or “heavy”, and if the reservation is considered “canceled” or “modified” can result in adjustments. Whether the customer has special requirements or preferences can result in adjustments. Rental rates, and revenue management can result in adjustments for maximizing overall revenue, profits or both. An amount of time that an equipment asset is unavailable (for maintenance, because it was rented, or for other reasons) can result in an adjustment. And, other adjustments can be made to reservation parameters, generally to suit the interests of a customer, or the facility, or both. In other words, the foregoing represent example reservation parameters that can be adjusted in connection with equipment rental, and others can be adjusted as well.

Accordingly, adjustments may be made for numerous reasons. The truck due to arrive may have broken down. A reservation may have been canceled. The customer may simply have rescheduled the terms of an initial or subsequent reservation for an earlier or later time. The customer may have initially wanted two pieces of equipment, then added a third one or more; the customer may have initially wanted two pieces of equipment, then removed one. The initially selected equipment may not be considered “rental ready” at any time prior to its possession being transferred, e.g., by being picked up. In other words, the equipment asset may have a maintenance issue and/or require maintenance, or need further upkeep or attention. Error may have emerged, by those in the yard, or the driver, or both. An equipment associate may have staged the wrong equipment asset. A certain customer may be accorded priority for the same equipment asset, such as where that customer's reservation reflects an earlier customer promise time. In addition, there may be a ripple effect where one adjustment creates the need for a further adjustment or multiple adjustments. Adjustments may be more likely to be made based on the type of information associated with the reservation.

Rules underlying an adjustment determination can be based on quantitative measures, such as times until expected transfer of possession of a given asset(s) to a first truck and second truck (and differential thereof); maintenance (e.g., time from last maintenance, amount on the meter, etc.); quantity of equipment assets; indication of an error status, warning or the like; the status of whether an equipment asset is “rental ready”; safety; economic benefits to the rental facility; number of feet walked or expected to be walked by an individual to assist in carrying out a given staging activity, such as personnel of the facility; and many more.

In addition, comments to a reservation may reflect that a customer has special requirements or preferences. These can be associated with the reservation itself. Such special requirements or preferences can lead to the determination that a given equipment asset be allocated that, absent such special requirements or preferences, would not have been so allocated, or at a given time to this customer. For example, there may be a default rule that, where multiple equipment assets may be available to meet customer needs, the equipment asset selected reflects one of the following: the one least recently used, oldest, one with lightest use (meter). In this manner, rules can be established governing overall equipment management practices yet accommodate the needs or requirements of a given customer.

In short, an equipment asset can be configured for customer needs and preferences as well as rental company needs and preferences, resulting in adjustments to an initial reservation of one or more customers.

Adjustments made herein can be accomplished dynamically, via a computer system that is handling two or more reservations, upon receiving information such as but not limited to a notification of a changed condition, such as expected time of arrival, number of equipment assets available, activity status reports in the course of staging activities, and many more.

Loading of the vehicle that is to carry away the asset, such as in conjunction with module 370, can be made more efficient by pre-loading. That is to say, an asset(s) can be preloaded onto a device that enables more efficient loading of the vehicle passing through the yard. The asset(s) preloaded can be any number of assets that the customer has expressed an interest in. A benefit of preloading is to avoid having to obtain an asset at or directly before vehicle arrival, ensuring the asset(s) will be found in the first place, that the asset has passed a maintenance check, undue yard activity is minimized, and other reasons.

In embodiments, visual elements 180 can be added or modified to the process herein. For example, special lanes can be painted in association with vehicle path 340 or otherwise visually provided so that an arriving vehicle can be directed into a predetermined path within the yard. Such path may be associated with a predetermined set of, and sequence of, activity modules through which it will pass. Additional vehicle paths, as well as activity modules, can be created, such as to and from office 310 through entry gate 380.

In addition, a cone can be placed on or associated with a predetermined vehicle path. Such cone can have a specified color, number displayed on the cone, or both. A number or other identifier can otherwise be associated with the lane, such as a number painted on the surface of asphalt, on associated signage, or other mechanism. Further, signage can be added pointing arriving vehicles in a certain direction, toward a certain path, or both. The signage can be relatively permanent (installed into the ground), or be readily removable (e.g., placed on a hook). For example, a specified vehicle can be directed via a set of same-color cones, same-number cones, or both. A given number of minutes or hours before arriving, the driver can notify the equipment associate of the driver's impending arrival. The equipment associate can tell the driver which lane to enter. The driver can enter the assigned lane (e.g., color-coded, number-coded or both). The driver can be unloaded and then loaded by means of logic based on the color, number or both.

The steps reflected in FIG. 1 can be employed in combination with additional disclosures herein, such as but not limited to activity modules, and functions, locations, and sequences thereof.

A computer-based display screen, such as but not limited to one associated with computer 212, can be used that contains information directing a driver with specified instructions. In addition, an individual such as an equipment associate can carry a visual element that will facilitate efficient vehicle arrival or exit, or can give oral instructions. A display screen, such as one associated with computer 212, can be used by an equipment associate, who can thereupon set up visual elements. This screen may not be (or may be) observable to an incoming driver. Signage can be customized depending on intended audience; for example, signage directed to those affiliated with the equipment rental company may be different (or not) than signage directed at third-parties, or vendors. Signage can for example include “Fueling Area—Do Not Enter”, “Please Stop Here—Exit to the Right”, and the like.

A desired in-yard vehicle path can comprise any number of shapes. However, in embodiments the path can be a polygon, such as one of a substantially rectangular shape 340, where entry gate 320 is located substantially proximal to one corner of a shorter segment, and exit gate 330 at the counterpart corner of the same shorter segment, and wherein there is a curved (or at least not completely linear) 345 portion at a given polygon segment describing where a vehicle turns from an entry path 342 to an exit path 344. Alternatively, entry 320 and exit 330 gates can comprise the same gate. Vehicle path 340 can be clockwise in the sense that a vehicle enters and after traversing the length of a relatively long segment turns right, traversing a relatively short segment, then right again. It can be arranged such that the activity module areas are on the driver's side of the cab, passenger's side, or a mix. The vehicle path can comprise other shapes, containing one curve or multiple curves, can be a straight line from one side of the facility to another, can be counterclockwise, and assume other forms.

In a related manner, the customer or intended party can be a factor in determining activity modules, sequence thereof, and vehicle path. For example, this combination may be different depending on whether the party is affiliated with the equipment rental company, is a third-party company, or a vendor. Put another way, it is possible that a driver on a flatbed truck operated by the equipment rental company may be directed down a vehicle path that includes inspection of the flatbed, tire inflation, special fueling activities, document signing activities, and so on.

Additional areas may assist with facilitating use of activity modules, specifically those modules that may be on a predetermined vehicle path. Such additional elements can include a ready line area separate from the modules along the vehicle path. The ready line area can include equipment assets that are ready to be transferred to the loading module, or to another area. An additional area can be a down area where miscellaneous activities can occur such as separating major repair from minor ones. A loading dock element can be provided to facilitate loading or unloading items.

Additional modules can be provided. One module is guiding a driver to follow an order accuracy process, which may involve pre-calls.

In embodiments, then, staging activities can occur via a process employing activity modules. The activity modules can be performed in a predetermined sequence. The activity modules can be performed such that there is no predetermined sequence. In addition, some subset of modules may be performed in a predetermined sequence, while others are not. The sequence can be determined in advance of a vehicle's arrival, or dynamically upon arrival, or a combination of both. The location of modules can be determined in advance of a vehicle's arrival, or dynamically upon arrival, or a combination of both. The nature and type of modules can be determined in advance of a vehicle's arrival, or dynamically upon arrival, or a combination of both.

It will also be understood that one module may not necessarily take place in isolation. For instance, loading does not necessarily take place in isolation. In other words, assets can be loaded where they are deemed available, such as after maintenance has been performed thereon, and based on other factors such as reallocating assets based on priority rules (e.g., compressor meant for customer one reallocated to customer two because it has been determined that customer two will arrive first). More broadly, then, activity modules can have an interrelationship where a first module can affect the nature, location and sequence of a second or successive module.

Activities performed in connection with the activity modules can be done by an individual who can take on the role of an equipment associate that will facilitate such activities, by the driver(s), both, or other or additional individuals. Activities performed by equipment associates can include chocking wheels, unchaining a load to be delivered, and unloading items. The equipment associate can also assist in loading items, and chaining the units to the vehicle for secure transport.

It will be appreciated that the yard can be configured so that there is positive vehicle “flow”. Such flow can contribute to recording lower vehicle turnaround times as measured from entry to exit. A suitable flow can occur where a gate permits entry of a truck, wherein the truck proceeds to activity modules in the following order: fuel, unload, load. Alternatively, fuel can be the final module. Fewer or more modules are possible. Loading can occur prior to unloading, where feasible. Additional functions and locations, and modules embodying such functions and/or locations, are possible.

Further actions can be taken to enhance productivity. For example, booms may be stored in the “down” position, i.e., not raised, thus minimizing need to cycle buckets. Also, a scissor area can be arranged in a “V”-like chevron style, increasing access to a given unit.

The methods disclosed and taught herein can apply to equipment rental as shown herein. However, the equipment rental methods disclosed and taught herein can be extended to subject matter related to allocating an item to a consumer of that item, whereupon the item is configured for transfer of possession and successive transport. Thus, the teachings herein can be applied to additional solutions.

While various details have been set forth in the foregoing description, it will be appreciated that the various aspects of the equipment staging process may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art.

It is worthy to note that any reference to “one aspect,” “an aspect,” “one embodiment,” or “an embodiment” means that a particular method, feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular methods, features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Any of the U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

One skilled in the art will recognize that the herein described methods, systems, components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “in operative communication”, “operably connected,” or the like to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

What is claimed is:

1. A method for staging equipment associated with an equipment rental facility, the method comprising:
recording, in a database, a reservation request by a customer for an equipment rental;
identifying equipment assets corresponding to the reservation request;
associating a specific equipment asset with the customer; and
adjusting a staging decision related to the equipment asset as a result of a change in a value of a reservation parameter, wherein the change in value of the reservation parameter is based, at least in part, on information input into a mobile computer device that is in physical proximity to an intended staging activity.

2. The method of claim 1, wherein the change in the value of the reservation parameter invokes use of a predetermined priority rule.

3. The method of claim 2, wherein the priority rule is based on a time period until the staging activity.

4. The method of claim 2, wherein the priority rule is based on actions to take upon notification that a reservation has been modified.

5. The method of claim 2, wherein the priority rule is based on actions to take upon notification that a reservation has been canceled.

6. The method of claim 2, wherein the priority rule is based on a continuous set of values.

7. The method of claim 2, wherein the priority rule is based on a binary set of values.

8. The method of claim 1, wherein the staging activity comprises positioning the equipment asset in a staging area within the facility, or removing the equipment asset from a staging area in the facility.

9. The method of claim 1, wherein the staging activity is performed at a predetermined location within the equipment rental facility.

10. The method of claim 1, wherein the equipment asset is allocated from a first customer to a second customer.

11. The method of claim 1, further comprising adding or modifying a visual element associated with the equipment rental facility to assist in performing the staging activity.

12. The method of claim 11, wherein the visual element is a vehicle lane, a sign, or a cone.

13. The method of claim 1, wherein the value of the reservation parameter is associated with a customer promise time.

14. The method of claim 1, wherein the value of the reservation parameter is associated with an error condition or warning condition.

15. The method of claim 1, wherein the value of the reservation parameter is a priority value.

16. The method of claim 1, wherein the value of the reservation parameter is a distance of the specific equipment asset from a computer device into which a reservation parameter is recorded.

17. The method of claim 1, wherein the value of the reservation parameter is associated with a “needs by” time.

18. The method of claim 1, wherein the value of the reservation parameter is associated with a determination that the specific equipment is rental ready.

19. The method of claim 1, wherein the value of the reservation parameter is associated with a special need or preference communicated by a customer.

20. The method of claim 1, wherein the value of the reservation parameter is associated with revenue management.

21. The method of claim 1, wherein the value of the reservation parameter is measured as a value along a continuous axis.

22. The method of claim 1, wherein the value of the reservation parameter is measured as a binary value.

23. A method for staging equipment associated with an equipment rental facility, the method comprising:
identifying an equipment staging function to be performed in the facility;
identifying an equipment staging location in an area of the equipment rental facility; and
adjusting the equipment staging function or equipment staging location based on a change in a value of a reservation parameter recorded in a computer device, wherein the change in value is based, at least in part, on information input into the computer device, and wherein the computer device is in physical proximity to the equipment staging location.

24. The method of claim 23, wherein the staging function is loading a vehicle.

25. The method of claim 23, wherein a determination is made to take a higher-priority action based on the value of a reservation parameter.

26. The method of claim 23, wherein the modification is made dynamically upon detecting a change in the value of a reservation parameter.
